(19) United States
(12) Patent Application Publication
(10) Pub. No.: US 2023/0386284 A1
(43) Pub. Date: Nov. 30, 2023

(54) Automated Access to a Property

(71) Applicant: Galaxi Networks, Inc., Sanday, UT (US)

(72) Inventors: W. Eric Smith, Pleasant Grove, UT (US); William B. West, Sandy, UT (US); Jory Dunn, West Jordan, UT (US); John Epeneter, Sandy, UT (US)

(21) Appl. No.: 18/201,984

(22) Filed: May 25, 2023

Related U.S. Application Data
(60) Provisional application No. 63/346,753, filed on May 27, 2022.

(51) Int. Cl. G07C 9/28; G06Q 50/16

(52) U.S. Cl. CPC G07C 9/28; G06Q 50/163

(57) ABSTRACT

Technology is described for providing automated access to a property. The method can include identifying an access request at an access agent. The access request can define a physical visit by a service provider during a defined time period at a property. An approval from a property representative may be received to create a scheduled visit in response to the access request. Another operation is receiving a notification from a device in communication with the access agent that a person is detected at the property at a scheduled visit time and location. The identity of the person may be authenticated as being the service provider using an authentication agent. An automation device under control of the access agent may be activated to enable physical access to property for the service provider.

### PRIORITY CLAIM

This patent application claims priority to provisional patent application 63/346,753 filed on May 27, 2022 with the title “AUTOMATED ACCESS TO A PROPERTY” which is incorporated by reference herein.

### BACKGROUND

The availability of automation devices (e.g., automated lights, light switches, motion detectors, garage door controllers, refrigerators, etc.), video cameras, large screen TVs, wireless audio equipment, IoT (internet of things) devices, electronic security systems and similar electronic equipment has continued to increase consumer interest in having and maintaining a home or business automation network. Over time, the electronics for automation systems have slowly become less expensive and there is a greater availability to buy many networkable electronic components and automation components that can be used to control lighting, control doors, control garage doors, monitor appliances, stream video or music, manage security systems, and automate a large variety of other electronic components using an automation network.

Many automation devices, security systems and other electronic systems can be networked into a central controller through a wired or wireless network. Examples of electronic components that an individual may desire to interface with a controller and an automation network can include: television screens, wireless audio equipment, video cameras, microphones, audio-visual and entertainment equipment, Alexa devices, Google devices, etc. Other types of devices that can be in communication with the controller can include automation equipment such as: door locks, lighting control switches, fireplace relays, dimmers, thermostats, HVAC, timers, garage door controllers, security systems and other types of automation and/or security equipment. In addition, other home and business equipment can be connected to a central controller and home automation network such as: USB devices, FireWire devices, serial and parallel communication devices, fiber optic connections, a computer network using an Ethernet or wireless connection (e.g., Bluetooth connections), and Internet connections.

### BRIEF DESCRIPTION OF THE DRAWINGS

FIG. 1 is a block diagram illustrating an example of an automation and security system that allows service providers to schedule access to a property where the automation and security system is installed.

FIG. 2 is a block diagram illustrating an example of the automation and security system that allows service providers to schedule access to a property using an access agent in a cloud computing network or server.

FIG. 3 is a block diagram illustrating software or hardware services that may be provided by an automation hub.

FIG. 4 is a flow chart illustrating an example of a method for automated access to a property.

FIG. 5 is a block diagram illustrating an example of computer hardware upon which the technology may be executed.

### DETAILED DESCRIPTION

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Installing and maintaining an automation network can be more complex than most consumers or businesses are interested in undertaking or even learning about. This is true even when only a few steps are needed for installation of each individual component. In addition, when automation network components fail or need maintenance, many owners would rather have a service provider come and fix the automation network as opposed to fixing the system themselves. Receiving assistance from a service provider in installing and maintaining an automation network, electronic systems, or other types of automation maintenance and services in their property is something many consumers or businesses like.

The present technology may include an automation and security system configured to make off the shelf automation devices and/or IoT (Internet of Things) devices work together in a seamless way. The types of automated devices that may be controlled by the technology may include door locks, light switches, smart doorbells, thermostats, motorized blinds, security systems, motion sensors, flood detectors, water shutoff valves, sensors, audio and video gear, irrigation systems, smart appliances, cameras, and any other smart electronic devices. For the term automation used herein, these automation electronic components that have been described can be used in many settings, including business, home, education, government, hotels, churches, and entertainment facilities.

Unlike many currently existing systems trying to achieve automation goals (e.g., Alexa, Samsung Smart Things, Google Home, Apple Home Kit to name a few), the present technology does not assume that user of the system will want to use a DIY (Do It Yourself) model for product installation and support. In contrast, the present technology provides the tools and/or features to allow companies to sell, install, and maintain these systems through a management system that includes dashboards for NOCs (Network Operation Centers), alerts, ticketing and scheduling software, CRM (Customer Relationship Management) integration and many other features and tools to enable complete and efficient support of customers.

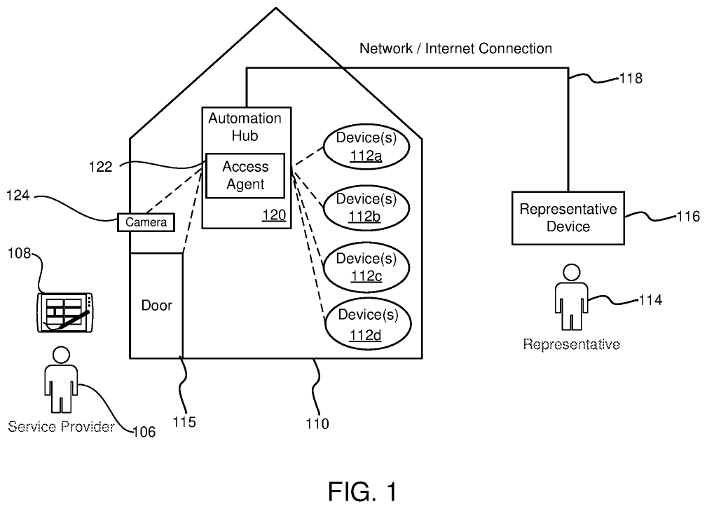

This technology may include a management tool or management system that is used to provide an access agent. FIG. 1 illustrates that the access agent 122 is a managing component of an automation hub 120 or an automation or security system. For example, the automation hub 120 may be part of a home automation and home security system, a business automation system, automation at a government site or another automation system. The access agent 122 may allow service providers 106 to send scheduling messages and/or access messages about a property 110 where the automation hub 120 is installed. The access agent 122 may have a defined amount of control of automation hub 120 and the automation and security system or business automation system. More specifically, the access agent 122 may have a defined amount of control over the access systems or devices (door locks, garage doors, etc.). For example, the automation and security system may be controlled by an automation hub 120 that may be connected to a plurality of automation devices 112a-d. The term property as defined here may include a home, a business, a building, office, warehouse, gated land, an apartment, a condo, or any other location where access is limited by security devices, security systems or other security devices.

A process for creating, validating, authenticating and enabling service visits to occur may start when a request message is sent by either 1) the property owner, 2) the service provider or 3) or third party scheduler to request a visit to the property (e.g., home, business, government site). This electronic request message with a visit request or access request may specify the service to be provided and have a time window for the access request with a specific start time and end time. Once the time is submitted by either party (e.g., agreed upon), the property representative 114 (e.g., homeowner, property manager, property agent) may receive a confirmation request message on the representative device 116 asking for permission for the service provider 106 to gain access to the property during a requested time window and to provide a specified service. For example, the service may be replacing a broken electronic device, installing an automation device, updating settings on an automation device, updating software on an automation device, revising the connections for an automation network, performing factory service or other services.

The property representative 114 (e.g., homeowner or business owner) can approve the access request for the visit in an approval app (communicating via the internet or a computer network 118) or through clicking on a link or button in a message that takes them to a secure web page of a web application to approve the access request for the visit. Other electronic approval interfaces may also be used, such as SMS texting, instant messaging services, email communications, or other electronic communication channels.

When the day and time arrives for the visit, the service provider 106 may arrive at the home and open the service app 108. The service app 108 may check the location given by the GPS of the service provider's mobile device and may compare that location with the access request for the visit currently scheduled for that service provider. If there is a match based on the location and time and the access request, the service app 108 can present the service provider with a user interface control to start the visit. For example, the service provide may click on a start visit control such as: a button, radio button, slider button, drop down window, etc. The service provider's mobile device may be cell phone, a laptop, tablet, or another mobile device that can report a GPS location to the service app 108. Alternatively, a camera 124 at the property may identify the service provider (e.g., facial recognition, fingerprint recognition, etc.) and then validate the service provider is the correct service provider if the visit records state that the visit is at the right time and place.

In one configuration, the start visit button can ask the service provider to re-authenticate in the service app 108 through a login or biometric check (e.g., Face ID, fingerprint recognition, iris recognition etc.). Re-authentication at the time of the visit may help ensure that the service provider's mobile device with the app on the mobile device has not been lost, stolen, copied or that another unexpected event has occurred where the service provider does not have possession of their mobile device at that time point.

After the authentication button has been activated and the authentication was successful, the access agent 122 may unlock the door 115, disarm the security system and/or start logging activity in the property through the automation devices 112a-d and/or other devices. The service provider 106 may then enter the property and perform the service defined in the access request and then may exit the home and shut the door 115. Cameras and other sensors (e.g., motion sensors, infrared sensors, sound monitors, LIDAR (light detection and ranging)) in the property can record the actions of the service provider 106 so that a record is kept regarding whether the correct service was provided and whether the service provider visited any locations that should not have been accessed.

Next, the service provider may open the service app 108 and click on an “end visit” button. At that time, the access agent 122 may lock the door and arm the security system and generate a report that includes the service done, the start and end times, locations visited at the property, and the device activity or human activity logged during the visit. An activity log may include the activation of any motion sensors, door sensors, window sensors, or any other automation devices. The activity log may also include video clips of motion captured by cameras, and any video recorded by the optional body camera that can be worn by the service provider. This activity log may be sent to the property representative 114, property owner and/or the service provider.

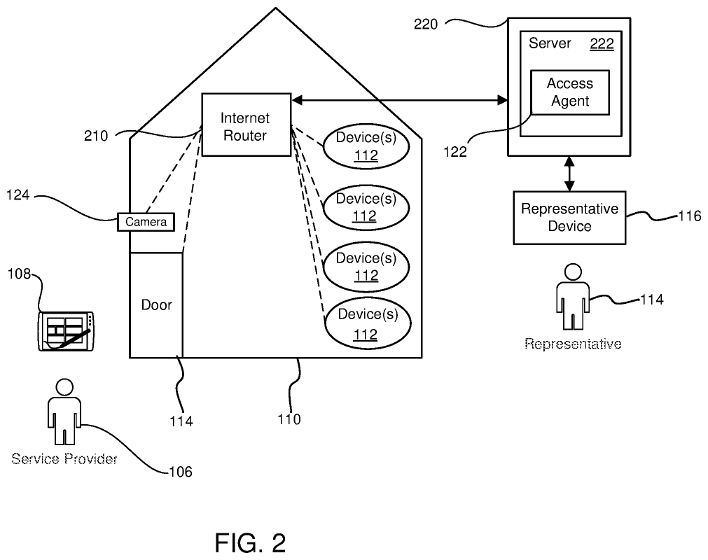

FIG. 2 illustrates a configuration of the present technology where the automation and security system are controlled by an access agent 122 from a server 222 in a public service provider environment 220 (e.g., on a public cloud), a private service provider environment (e.g., a private cloud) or a data center. The access agent 122 may be controlled, accessed or modified through a console or graphical user interface provided through a web browser, an app on a mobile device, a dedicated tablet, or a desktop computer. The access agent 222 may be able to access the automation network through an internet router 210. The access agent 122 may be a service that is executing on the server 222 or the access agent 122 may execute on a serverless compute service in the public service provider environment 220 or cloud.

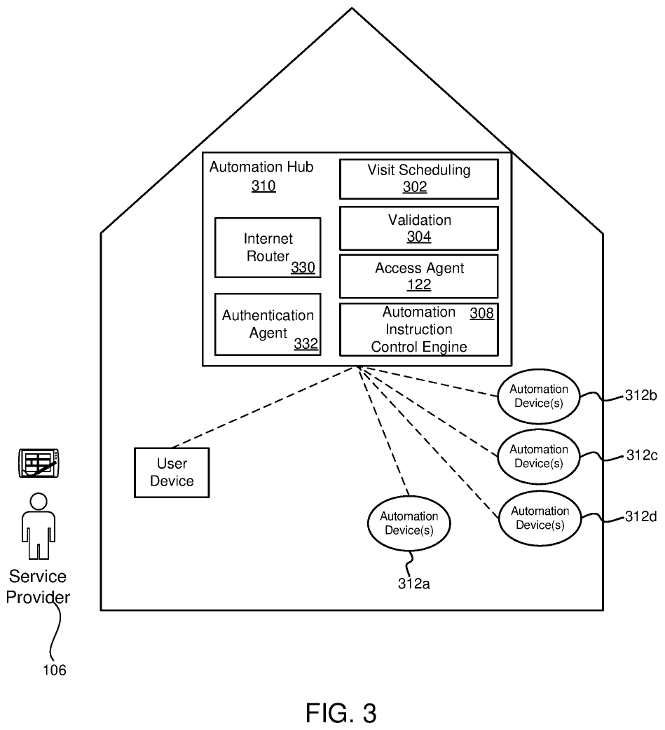

FIG. 3 is a block diagram illustrating additional services that may be provided by an automation hub 310. The automation hub 310 may include an internet router 330 through which automation devices 312a-d may communicate with the internet, as controlled by the automation hub 310. The automation devices 312a-d may also be connected directly to the internet, if desired. A visit scheduling service 302 may be provided to receive request messages to schedule visits from service providers 106. Alternatively, request messages may be sent by a property representative, property manager or property owner to the visit scheduling service 302 in order to schedule service visits.

In one embodiment, a service provider 106 may schedule the next visit by entering the access request or visit request directly into the automation hub 120 when the service provider is on the property. For example, if a service provider is changing an air filter in a HVAC unit. The next appointment for changing the air filter may be scheduled while on-site. The new access request may be entered into the automation hub using a touch screen interface, a voice command interface, a keyboard interface or a pointing device interface (e.g., a mouse, an electronic pen, etc.)

A validation service 304 may be provided to validate the location and time when a service provider 106 arrives to perform services. The validation service 304 may be used by the access agent 122 to verify that the correct time and date for the visit has arrived. In addition, the validation service 304 may validate that the correct service provider 106 is at the location. For example, if the incorrect person shows up at the location, the incorrect service provider may be authenticated if the service provider performs services for other property owners through this technology. If the wrong service provider shows up at a location at an already existing service time and authenticates, then that service provider is not the correct service provider who the access request or service, and the incorrect service provider may be blocked from entering the property (unless the property owner provides further approvals).

An access agent 122 may also have control over an automation instruction control engine 308 that controls the automation devices in order to grant access to a service provider. Accordingly, the access agent 122 may be able to initiate or execute pre-stored scripts for obtaining access to the property or locking the property. Additionally, the access agent 122 may also access scripts for activating the tracking of movement in the property, tracking service agent activities, or capturing of video in the locations where the service provider 106 is doing work. The access agent 122 may be able to run scripts, programs or other control sequences that are executable on the automation network and automation devices 312a-d.

An authentication agent 332 or service may also be provided to authenticate the identity of a service provider 106 who is attempting access to the property. The authentication may be through face recognition, finger print recognition, or another biometric authentication type. The authentication may also be performed using a password, a one-time password (OTP) or another shared secret authentication method.

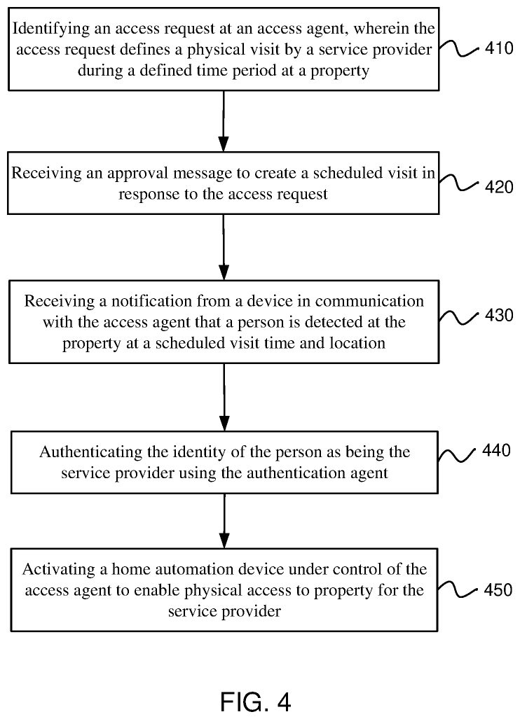

FIG. 4 is a flow chart illustrating the operations for automated access to a property. The system and method may be able to recognize that a service provider authorized to perform a service for the property (e.g., a business or home) has arrived on site at the right time and has been authenticated. In addition, the system may being capable of knowing about scheduled visits by a service provider (i.e., a service provider that is an individual, company or one of a group of companies) that are approved by an approval message from an approval application on a device used by the property owner (or their representative).

The method may include identifying an access request at an access agent, as in block 410. The access request may define a physical access (e.g., a physical visit by a service provider) during a defined time period at a property. The initial access request may include receiving a notification, at the access agent, and the notification may define a pending but unconfirmed visit (i.e., a potential visit) by a service provider during the defined time period at a property. In addition, the notification may come from the service provider, the service provider's agent, the property representative, the property owner or a third party scheduler. The access agent may be located on an automation hub at the property or the access agent may be located on a public cloud private cloud, or in a data center.

An approval message from an approval application on a device as used by a property representative may be received to create a confirmed, scheduled visit in response to the access request, as in block 420. This approval message may be in response to a confirmation request for the scheduled visit that was sent regarding the access request during the defined date and time period. The confirmation request may be sent to a property representative using an approval device a computer network or the internet. An approval device may be a computing device with an approval application on the device that can be used by a property representative to generate the approval message. The approval application can validate that the property representative is the correct person to use the application to send the approval message. For example, the property representative may authenticate the identity of themselves or another person and validate the property representative's rights to generate or authorize approval messages.

In addition, a notification may be received from a device in communication with the access agent and the notification may be regarding a person that is detected at the property at a scheduled visit time and location, as in block 430. The access agent may determine: the service provider is authorized to do a service on the property, has arrived during the defined time period and needs to be authenticated prior to granting access to the property. One way of determining that the service provider is at the correct location of the property may be using GPS (global positioning system) coordinates from a mobile device of the service provider.

The identity of the person may be authenticated as being the service provider who is allowed to perform the desired service by using an authentication agent, as in block 440. The device used to detect the presence of the service provider may be: a mobile phone, a mobile device, a visual camera fixed to the property, an infrared camera, a LIDAR (Light Detection and Ranging) device, or an automation device. Then the identity of the service provider may be performed using an authentication agent using: biometric authentication, supplying a code, supplying a password, having a programmed hardware key or other existing authentication techniques. The authentication agent may be in the automation hub at the property or the authentication agent may be on a cloud hosted service.

An automation device may be activated under control of the access agent to enable physical access to the property for the service provider, as in block 450. For example, the automation device under the control of the access agent may be activated by performing at least one of: unlocking a door (e.g., a deadbolt, or magnetic lock, smart knob, or any other door lock), opening a door (e.g., garage door or other motorized door), disarming a security system, or taking another automation action that enables entry for the service provider. Thus, the access agent of the system may grant access by instructing an automated device to open and allow entry. Alternatively, the access agent may deny access to the property when: the service provider arrives outside the defined time period, the service provider is not at the property, or an identity of the person cannot be authenticated as the service provider, etc.

The completion of a visit may be detected by the access agent. For example, the access agent may detect the service provider left the premises using video and/or sensors. In another example, the service provider may directly notify the access agent that the service provider has left the property.

The access agent may return one or more home automation devices to an original state by, for example, locking a door (e.g., deadbolt, or magnetic lock, smart knob, or any other door), closing a door (e.g., garage door or other motorized door), arming a security system or taking another automation action that returns the automation devices to an original state prior to the service provider visit. Examples of the automation devices in this operation may be a door activator or a security system. For example, the door activator may be: an automated deadbolt, a magnetic lock, a smart knob, a garage door opener, a motorized door or any other type of door activator which can open a door.

The access agent may send a report of a visit to the property representative that includes logged information from a plurality of automation devices. The report may have any parts of or all of the logged information that was logged for the automation devices or security system while the service provider was at the property. For instance, the system may be able to log data from one or more connected devices that could include cameras, sensors, control devices, automation devices, etc. This report may include providing access to recorded data from a body camera worn on the service provider through the access agent or a user interface linked to a visit. Alternatively, the video from the body camera of the service provider may be sent to the property representative using a web link or other known data storage access mechanisms.

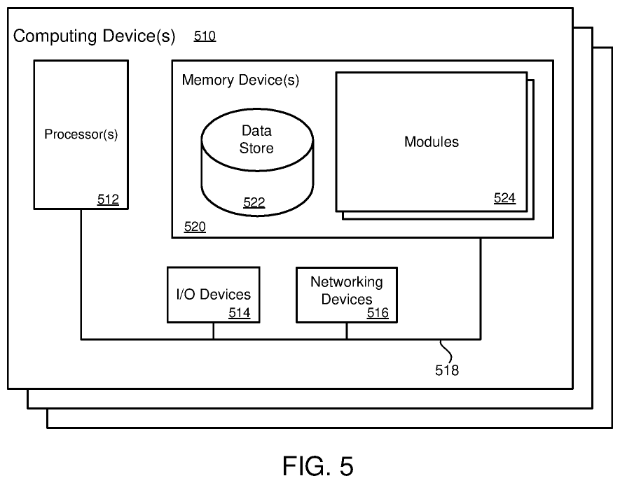

FIG. 5 illustrates a computing device 510 which may execute the foregoing subsystems of this technology. The computing device 510 and the components of the computing device 510 described herein may correspond to the servers and/or client devices described above. The computing device 510 is illustrated on which a high-level example of the technology may be executed. The computing device 510 may include one or more processors 512 that are in communication with memory devices 520. The computing device may include a local communication interface 518 for the components in the computing device. For example, the local communication interface may be a local data bus and/or any related address or control busses as may be desired.

The memory device 520 may contain modules 524 that are executable by the processor(s) 512 and data for the modules 524. For example, the memory device 520 may include an inflight interactive system module, an offerings subsystem module, a passenger profile subsystem module, and other modules. The modules 524 may execute the functions described earlier. A data store 522 may also be located in the memory device 520 for storing data related to the modules 524 and other applications along with an operating system that is executable by the processor(s) 512.

Other applications may also be stored in the memory device 520 and may be executable by the processor(s) 512. Components or modules discussed in this description that may be implemented in the form of software using high programming level languages that are compiled, interpreted or executed using a hybrid of the methods.

The computing device may also have access to I/O (input/output) devices 514 that are usable by the computing devices. An example of an I/O device is a display screen that is available to display output from the computing devices. Other known I/O device may be used with the computing device as desired. Networking devices 516 and similar communication devices may be included in the computing device. The networking devices 516 may be wired or wireless networking devices that connect to the internet, a LAN, WAN, or other computing network.

The components or modules that are shown as being stored in the memory device 520 may be executed by the processor 512. The term “executable” may mean a program file that is in a form that may be executed by a processor 512. For example, a program in a higher-level language may be compiled into machine code in a format that may be loaded into a random-access portion of the memory device 520 and executed by the processor 512, or source code may be loaded by another executable program and interpreted to generate instructions in a random-access portion of the memory to be executed by a processor. The executable program may be stored in any portion or component of the memory device 520. For example, the memory device 520 may be random access memory (RAM), read only memory (ROM), flash memory, a solid-state drive, memory card, a hard drive, optical disk, floppy disk, magnetic tape, or any other memory components.

The processor 512 may represent multiple processors and the memory 520 may represent multiple memory units that operate in parallel to the processing circuits. This may provide parallel processing channels for the processes and data in the system. The local interface 518 may be used as a network to facilitate communication between any of the multiple processors and multiple memories. The local interface 518 may use additional systems designed for coordinating communication such as load balancing, bulk data transfer, and similar systems.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. A method for automated access to a property, comprising:
identifying an access request at an access agent, wherein the access request defines a physical visit by a service provider during a defined time period at the property and is approved using an approval message;
receiving an authentication of an identity of a person, detected at the property at a scheduled visit time, as being the service provider using an authentication agent; and
activating an automation device under control of the access agent to enable physical access to property.

2. The method as in claim 1, further comprising tracking activities of a service provider using automation devices located at the property.

3. The method as in claim 2, further comprising reporting service provider activities as detected by automation devices to a property representative.

4. A method for automated access to a property, comprising:
identifying an access request at an access agent, wherein the access request defines a physical visit by a service provider during a defined time period at the property;
receiving an approval message from an approval application to create a scheduled visit in response to the access request;
receiving a notification from a device in communication with the access agent that a person is detected at the property at a scheduled visit time and location;
authenticating the identity of the person as being the service provider using an authentication agent; and
activating an automation device under control of the access agent to enable physical access to the property for the service provider.

5. The method as in claim 4, wherein the device is at least one of: a mobile phone, a mobile device, a visual camera fixed to the property, an infrared camera, a LIDAR (Light Detection and Ranging) device, or an automation device.

6. The method as in claim 4, sending a confirmation request, using a computer network, to a property representative regarding the access request during the defined time period.

7. The method as in claim 4, further comprising receiving a notification, at the access agent, wherein the notification defines a potential visit by a service provider during a defined time period at the property.

8. The method as in claim 4, further comprising determining that the service provider authorized to do a service on the property has arrived during the defined time period and has been authenticated prior to granting access to the property.

9. The method as in claim 4, further comprising determining the service provider is at a location of the property using GPS (global positioning system) coordinates from a mobile device of the service provider.

10. The method as in claim 4, further comprising denying access to the property when: the service provider arrives outside the defined time period, the service provider is not at the property, or an identity of the person cannot be authenticated as the service provider.

11. The method as in claim 4, wherein the access agent is located on an automation hub at the property.

12. The method as in claim 4, wherein the access agent is located on a public or private cloud.

13. The method as in claim 4, further comprising activating the automation device under the control of the access agent to perform at least one of: unlocking a door, opening the door, or disarming a security system.

14. The method as in claim 4, further comprising detecting completion of a visit and returning one or more home automation devices to an original state by at least one of: locking a door, closing a door or arming a security system.

15. The method as in claim 4, wherein the automation device is at least one of: a door activator or a security system.

16. The method as in claim 15, wherein the door activator further comprises at least one of: an automated deadbolt, a magnetic lock, a smart knob, a garage door opener or a motorized door.

17. The method as in claim 4, wherein authenticating an identity of the service provider is performed using at least one of: biometric authentication, supplying a code, supplying a password or having a programmed hardware key.

18. The method as in claim 4, further comprising sending a report of a visit to a property representative that includes logged information from a plurality of automation devices.

19. The method as in claim 4, further comprising providing access to recorded data from a body camera worn on the service provider.

20. A non-transitory computer readable storage medium having instructions embodied thereon, the instructions when executed by one or more processors, cause the one or more processors to perform a process, including:
identifying an access request at an access agent, wherein the access request defines a physical visit by a service provider during a defined time period at a property;
receiving an approval from an approval application to create a scheduled visit in response to the access request;
receiving a notification from a device in communication with the access agent that a person is detected at the property at a scheduled visit time and location;
authenticating the identity of the person as being the service provider using an authentication agent; and
activating an automation device under control of the access agent to enable physical access to the property for the service provider.

21. The non-transitory computer readable storage medium as in claim 20, sending a confirmation request, using a computer network, to a property representative regarding the access request during the defined time period.

22. The non-transitory computer readable storage medium as in claim 20, further comprising determining that the service provider authorized to do a service on the property has arrived during the defined time period and has been authenticated prior to granting access to the property.
